(19) United States
(12) Patent Application Publication
(10) Pub. No.: US 2019/0174304 A1
(43) Pub. Date: Jun. 6, 2019

(54) Universal Authentication and Data Exchange Method, System and Service

(71) Applicant: NXT-ID, Inc., Shelton, CT (US)

(72) Inventors: Charles David Tunnell, Palm Bay, FL (US); Justin Mitchell, Melbourne, FL (US); Jacob Zurasky, Orlando, FL (US)

(21) Appl. No.: 16/172,667

(22) Filed: Oct. 26, 2018

Related U.S. Application Data
(63) Continuation-in-part of application No. 14/217,289, filed on Mar. 17, 2014, now abandoned.
(60) Provisional application No. 61/802,681, filed on Mar. 17, 2013.

(51) Int. Cl. H04W 12/00; H04W 12/06; H04L 29/06; H04W 4/80

(52) U.S. Cl. CPC H04W 12/003; H04W 12/0608; H04L 63/0807; H04L 2463/082; H04L 63/0838; H04W 4/80; H04L 63/0861

(57) ABSTRACT

A method for authenticating a first entity to a second entity. The first entity supplies a first authentication credential to the second entity using a first communication scheme, and the first entity supplies a second authentication credential to the second entity using a second communication scheme. The second authentication credential is different from the first authentication credential and the second communication scheme is different from the first communication scheme. The first and second entities are authenticated responsive to the first and second authentication credentials. The first and second communication schemes may comprise different communication frequencies or different modulation types.

### CROSS REFERENCE TO RELATED APPLICATIONS

This is a continuation-in-part patent application that claims the benefit of U.S. patent application filed on Mar. 17, 2014, assigned application Ser. No. 14/217,289, entitled Universal Authentication and Data Exchange Method, System, and Service (Attorney Docket 12188-011), which claims the benefit of the provisional patent application filed Mar. 17, 2013 and assigned Application No. 61/802,681, (Attorney Docket Number 12188-009), both of which are incorporated herein.

### FIELD OF THE INVENTION

The present invention relates to the general field of device or entity authentication and secure data exchange between authenticated devices or entities.

### BACKGROUND OF THE INVENTION

Throughout history, physical keys have been used to access various doors (such as but not limited to house, car, business, storage, or other doors), safes and/or vaults, weapons, entertainment systems, home automation electronics, networks, and other personally accessible systems, devices, containers, locations, and the like. With the advent of the computer age, access to these personal items expanded to computers, devices, applications, services, and other hardware and software devices (referenced hereafter as “endpoints”) that have utilized passwords (something a user knows) to control access and exchange data. As the number and variety of devices, applications, and services has proliferated, the sheer number and type of passwords has become burdensome to users. A natural response from users is to use the same password in multiple locations or to choose a password so simple, it's impossible to forget. In turn, users end up with unsecure passwords and hacked accounts.

The End of Passwords: Passwords have invaded virtually every aspect of life. Authentication methods such as passwords have historically been ineffective at reliably authorizing access to devices, doors, locks, home automation, entertainment systems, servers, and other hardware devices referenced hereafter as “endpoints.” Likewise, websites, services, applications, networks, cloud services, portals, software and the like, referenced hereafter as “software”, have proven just as challenging to protect, while providing access to other authorized users, midpoints, endpoints, (where midpoints are devices, websites, software, etc. through which two endpoints communicate; the endpoints also comprise devices, websites, software, etc.) software and the like, referenced hereafter collectively as “entities”. In addition, passwords and equivalent authorization techniques are used with other hardware and software entities including but not limited to firewalls, routers, bridges, and many other switch and network entities that serve some function between an endpoint and a user, referenced hereafter as “midpoints.”

Other Password-Based Methods: The primary motivation of login credentials such as passwords is to give some assurance that individuals “are who they say they are.” Unfortunately, passwords provide little security. It is estimated that every single person has forgotten a password at some point in their lives, resulting in lost time and productivity, not to mention patience. Most individuals are reluctant to select new passwords and instead use the same passwords across multiple entities, which further reduces security. Simply accessing all passwords with a “master password” as is done with password managers is counterproductive, since the master password is susceptible to intercept just like any other password. Furthermore, with this method, if the master password is compromised, so are all of the passwords. The purpose of using passwords as an authentication method is to attempt to validate you are who you say you are with “something you know”. Other methods such as security dongles attempt to test “something you have” and biometrics attempt to determine “someone you are”. Unfortunately, any of these methods alone are just as susceptible as passwords if intercepted.

Insecurity in passwords and physical keys is pushing new collaborative technologies. Methods such as but not limited to “eKeys” are replacing physical keys with an electronic ID (identification). Open standards such as but not limited to OATH (Open Authentication) attempts to strengthen authentication and make access ubiquitous. Other methods include password managers to manage all passwords and electronic codes and/or keys.

Password management solutions typically consist of software that enables users to organize and encrypt passwords, pass phrases, pin codes and the like (collectively “passwords” hereafter) into some database repository that can then be used to provide login credentials. Many desktop and browser-based password managers store passwords locally on hard drives, leaving the repository susceptible to hackers. Some add encryption as a method to protect the repository. Unfortunately, the strength of these local password managers is only as good as the master password that is used to access encrypted passwords within the repository.

Similar to local password managers, web and cloud-based remote password managers are dependent upon the quality of a single password to access and decrypt a repository of passwords. Likewise, other alternatives such as but not limited to OpenID, Microsoft's Passport (now Windows Live ID), LastPass, and Apple's keychain typically utilize single sign-on techniques. Although such password managers offer convenience, compromise of this one single password will compromise all passwords within the repository. In addition, passwords over the Internet are more susceptible to intercept if users do not take appropriate precautions. Users that trade security for convenience with a single weak password left by itself to protect a repository of encrypted passwords leave themselves susceptible to a common cyber attack.

Unfortunately, virtually any method that involves password entry via a computer, phone, browser and the like is susceptible to attack. Techniques that intercept passwords include cryptanalysis and key loggers. Some methods such as but not limited to virtual keyboards reduce risk of intercept. Methods such as but not limited to password generators attempt to improve the relative “strength” of the password, but these too can be “guessed” if the random number generator used to generate the password is weak.

Promising methods to improve security to passwords include multi-factor authentication (MFA), where two or more “factors” are used to authenticate a user. Hardware devices with security tokens such as but not limited to USB dongles and smart cards also further strengthen multi-factor authentication. In addition to adding convenience by enabling passwords to be portable between computing devices, token-based methods provide improved security over passwords because they require hardware that is “physically present” as well. Token-based methods may also include protocols such as but not limited to one-time passcodes/passwords (OTP) and single sign-on (SSO) methods.

2-Factor authentication is a method that requires two methods to authenticate. One method is typically sent via text message to phones, email confirmation, or via a phone call confirmation just to introduce another communication channel.

Multi-factor authentication has been introduced as an approach to improve authentication. MFA requires two or more factors to authenticate. Authentication factors generally consist of:
Knowledge—“something you know”
Possession—“something you have”
Biometrics—“someone you are”
   Knowledge factors include passwords (secret words or phrases), PIN (personal identification number), and patterns (sequence(s) of cells). Possession factors include tokens (FOB, USB, contactless RFID, and the like), smart cards, etc. Biometric factors are typical biometric identifiers such as finger, face, voice and IRIS, among others.

Asymmetric and symmetric encryption methods provide some security advantages against intruders. Symmetric algorithms for encrypting data use the same key for both encryption of plain text and decryption of cipher text. The keys may be identical or there may be a simple transformation of one key to produce the second key. The keys, in practice, represent a shared secret between two or more parties that can be used to maintain a private information link. Asymmetric encryption (also referred to as public-key cryptography, refers to a cryptographic algorithm that requires two separate keys, one of which is secret or private and the other of which is public. Although different, the two parts of this key pair are mathematically linked. The public key is used to encrypt plain text and the private key is used to decrypt cipher text.

Regardless of the authentication method, there are various disadvantages associated with the prior art techniques for maintaining security when setting up a communication link and exchanging data over that link. The disadvantages include synchronization, certificate authorities, and integration that may make implementation unattractive.

### SUMMARY OF THE INVENTION

The disclosed invention may be used to access and securely exchange data among entities or devices, including, for example, users, websites, services, software-based applications, devices, networks, entertainment systems, home automation equipment, doors, locks or other software or hardware entities or devices. Certain embodiments may allow for devices or entities to be accessed securely without passing plain-text passwords through standard web or front-end interfaces. Other embodiments allow use of one or a combination of authentication techniques and credentials. As used herein an authentication technique refers to identification of a user, entity, or device based on one or more authentication credentials.

Such authentication techniques comprise, but are not limited to, secure one-time-passcodes (OTP), challenge/response queries, multi-factor authentication (MFA), asymmetric techniques, PKI, PGP, and/or symmetric techniques, for example. Further embodiments generate “biometrically-infused” security tokens and/or passwords. Yet other embodiments use a combination of public-key infrastructure (PKI) and/or private keys to perform authentication and/or encryption and/or decryption to exchange data between devices or entities. Finally, to achieve ultimate authentication and encryption without the use of vulnerable static cryptography techniques, other embodiments may use dynamic pairing alone or in combination with other methods.

For devices or entities that do not provide full integration of authentication services, the invention operates as a secure authentication device, referred to herein as an authenticator.

Independent of the authentication techniques or credentials that are utilized, the invention supports multiple communication parameters, methods or protocols including sound, RF (radio frequencies), imagery, QR codes (e.g., two-dimensional images), light, baseband, parallel communication methods, and serial communication methods such as but not limited to USB and RS-232.

The selection of a communication parameters may inherently select a desired communication path (sometimes also referred to as a channel), e.g., a USB communication method necessarily uses a serial bus. However, other communication methods allow the selection of a communication path that is most effective for carrying out the selected method or protocol.

Additionally, as used herein, communication parameters comprise any modulation scheme (e.g., linear modulation, exponential modulation, and digital modulation), propagation at any frequency, any coding/decoding, encryption/decryption and compression/decompression techniques.

Any one or more of these communication methods may be used to send wake-up signals, authentication credentials, and encrypted data to other entities, achieving a universal and adaptable authentication and data exchange device for end-to-end secure communications.

### BRIEF DESCRIPTION OF THE DRAWINGS

The forgoing and other features of the present invention will be apparent to one skilled in the art to which the present invention relates upon consideration of the description of the invention with reference to the accompanying drawings, herein:

FIG. 1 illustrates a universal authentication and data exchange device according to the present invention.

FIG. 2 describes a functional block diagram of an embodiment of a universal authentication device according to the present invention.

FIG. 3 illustrates a companion application in conjunction with an authenticator to access host devices and entities, and remote devices and entities.

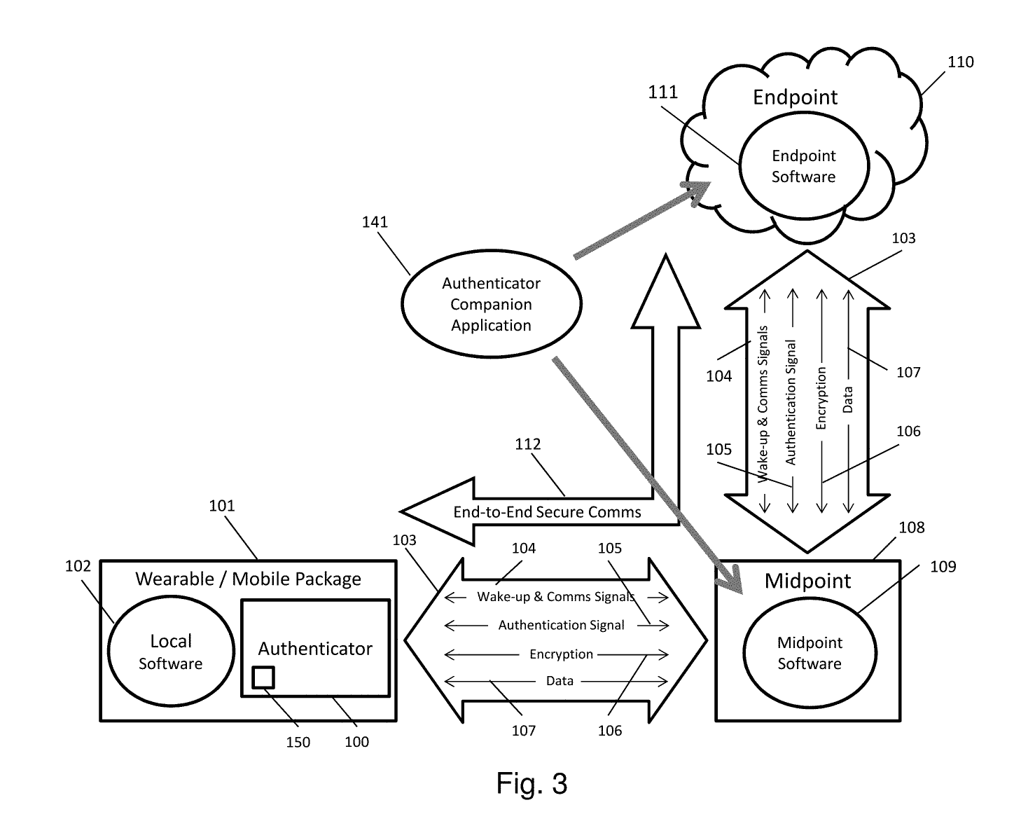

### DETAILED DESCRIPTION OF THE PREFERRED EMBODIMENTS

Before describing in detail the particular methods and apparatuses related to universal authentication and data exchange methods, systems and services, it should be observed that the embodiments of the present invention reside primarily in a novel and non-obvious combination of elements and method steps. So as not to obscure the disclosure with details that will be readily apparent to those skilled in the art, certain conventional elements and steps have been presented with lesser detail, while the drawings and the specification describe in greater detail other elements and steps pertinent to understanding the embodiments. The presented embodiments are not intended to define limits as to the structures, elements or methods of the inventions, but only to provide exemplary constructions. The embodiments are permissive rather than mandatory and illustrative rather than exhaustive.

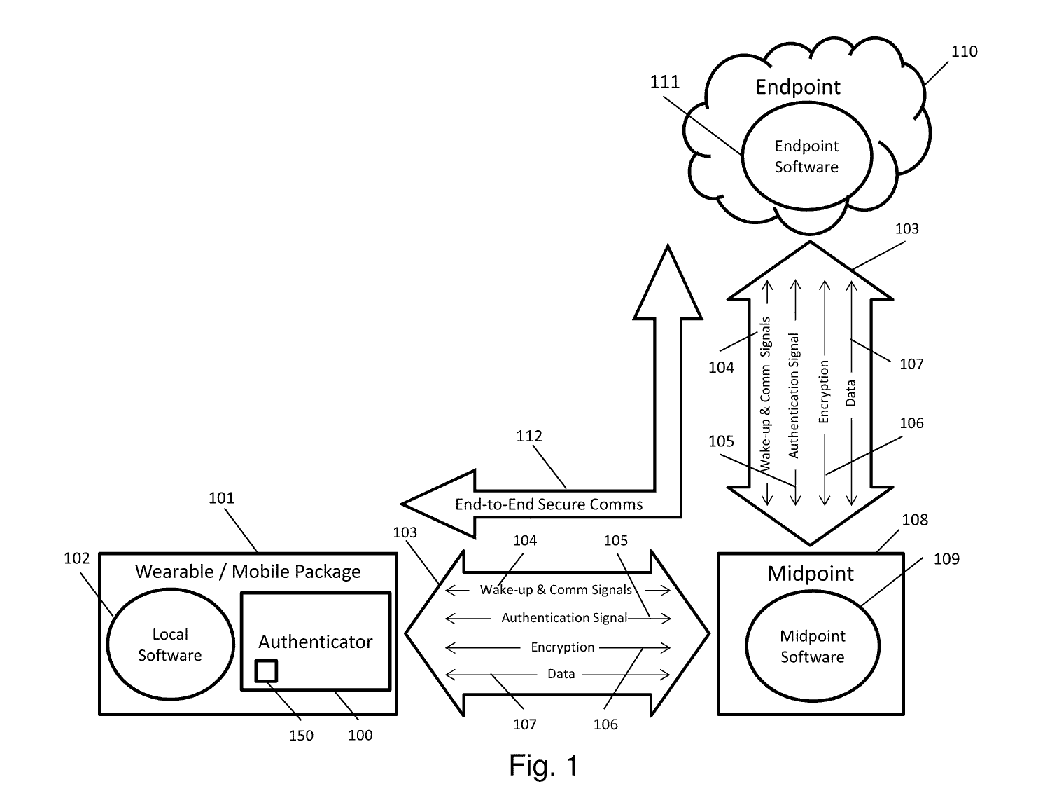

To serve as a bridge from passwords to multi-factor authentication and other forms of authentication that are being introduced, this invention provides a universal authentication service that supports multiple authentication techniques within a single system implemented in software and/or hardware, referenced herein as an “authenticator” 100 in FIG. 1. Those skilled in the art are aware that the authenticator and/or the functionality embodied therein can be incorporated into any device or entity that requires user authentication before granting user access.

The overarching objective of the invention is to simplify establishing a secure and effective communications session for communicating between a first and second device (more broadly referred to as first and second entities). And to prevent a hacker from hijacking that session while it is being established or while in operation (or at least reduce the probability that a hacker can gain access to the communications session).

The present invention, supports multiple data exchange techniques (also referred to as communication parameters). As used herein the phrase communication parameters is intended to include any parameter that is necessary to carry out effective communications between two devices or two entities. For example, one such parameter includes a frequency to be used by both first and second entities for exchanging data. Another parameter may be a communication protocol (e.g., Bluetooth of WiFi) and yet another parameter may relate to a data compression scheme.

Since no single standard authentication or data exchange scheme exists, this invention seeks to support the multitude of communication, authentication, coding, encryption, and compression schemes and authentication credentials with one universal method and system that negotiates (or somehow determines) authentication and data exchange parameters between devices, (where the devices may be referred to as authenticators, endpoints, midpoints), users, and other entities.

As used herein, negotiate refers to determining a common (i.e., supported by both) communication method/protocol, communication channel, authentication techniques and credentials, encryption scheme, etc. that allow two devices to communicate over a secure channel.

The negotiation can occur when a first device contacts a second device to determine whether the first and second devices share a common authentication technique (or any one of the other multiple parameters and protocols that are necessary to have effective communications between the first and second devices, e.g., data compression, modulation/demodulation, encryption).

Alternatively, the first device sends a signal to the second device, wherein the signal embodies a specific modulation scheme, encryption scheme, compression scheme, etc. If the second device is able to interpret the received signal a response signal is returned to the first device indicating that the signal was received and correctly interpreted. Absent receipt of the response signal, the first device resends the signal using one or more different parameters. This process of resending and awaiting a response signal continues until the first and second devices have established all necessary parameters to carry out effective communications therebetween.

In yet another example of establishing all communications parameters, the first and second devices may have predetermined an encryption scheme, for example, that governs all communications between these devices.

In still another example, if the first and second devices communicate according to a known protocol (802.11n, for example), the protocol itself may establish certain ones or all of the communications parameters that are necessary for effective communications between the first and second devices.

Thus, the present invention supports multiple communication parameters (e.g., frequencies and communication paths). The disclosed invention provides a flexible authentication and communications system in which an entity can authenticate with and/or engage in secure data communications with other entities. No other devices, software or systems are needed as the Universal Authentication and Data Exchange Method, System, and Service provides all functions necessary to provide secure communications between entities.

Generally, to establish an effective communications link between two devices, the devices must agree on the following communication parameters: a frequency of the signal propagated between the two devices, a signal multiplexing scheme (e.g., frequency hopping), a modulation scheme (analog or digital) and modulated parameter (e.g., amplitude, phase or frequency), a specific analog (e.g., AM or FM) or digital modulation scheme (e.g., QPSK, QAM, BPSK), a data baud rate, a coding/decoding scheme, an encryption scheme, a compression scheme, and a data set. If a sending and receiving device both employ the same signal processing schemes, then the initial baseband scheme (0's and 1's) at the sending end is retrieved at the receiving end. Those skilled in the art may be aware of other parameters that must be established for effective communications between a sending device and a receiving device.

Functional Description: An authenticator 100 (within a wearable or mobile device or package, for example) of FIG. 1 in one embodiment connects, via a communications link or path 103, to one or more midpoints 108 (comprising midpoint software 109), endpoints 110, (comprising endpoint software 111) that require authentication to gain access by a user, application, service, device or other entity.

The references to the authenticator, midpoints, and endpoints are merely exemplary, as anyone or more of these can represent devices, entities, users, software applications, etc. as set forth herein. Each of the devices and entities of FIG. 1 can interact over various communication links or paths 103 (sometimes referred to as communication channels).

An authenticator responds to any one or more of the following to initiate a secure communications session between devices and entities: a wake-up signal and communications signals, 104, authentication signals and/or credentials 105, encrypted data 106, and compressed or uncompressed data 107. These are merely examples of signals and actions that can be used to initiate communications between any two devices.

Once authenticated, the authenticator provides a secure communication gateway for all authenticated entities to communicate securely end-to-end, as indicated by an arrowhead 112. Thus, any devices or entities, including those depicted in FIG. 1, and any combinations thereof may communicate securely.

As a non-limiting example, in one embodiment, the authenticator 100 is connected directly to endpoints 110 and/or endpoint software 111, without an intervening midpoint 108.

In various applications, the midpoint 108 may comprise an application, website, service or other software, referenced hereafter as the “midpoint software” 109.

At times the midpoint 108 may communicate with endpoints 110 and/or other endpoints and midpoints (not shown) (each including endpoint software 112 and/or midpoint software 110).

Non-limiting examples of endpoints 110 include computers, mobile devices, locks, servers, cloud or other entities. Endpoints 110 may also have applications, services and/or other software referred to as “endpoint software” 111.

Non-limiting examples of midpoints 108 include firewalls, routers, bridges, and many other switch and network entities that serve some function between endpoints and authenticators or another entity or user. Midpoints 108 may also have applications, services and/or other software referred to as “midpoint software” 109.

Pertinent features of the authenticator 100 include the ability to securely protect secrets, identifiers (unique to users and entities), credentials, passwords, public and private keys and/or other authentication methods and/or credentials. Support for various authentication methods 105 and the ability to exchange authentication credentials with other midpoints 108 and endpoints 110 and their corresponding software 109, 111, over a variety of communication links 103 may vary as required.

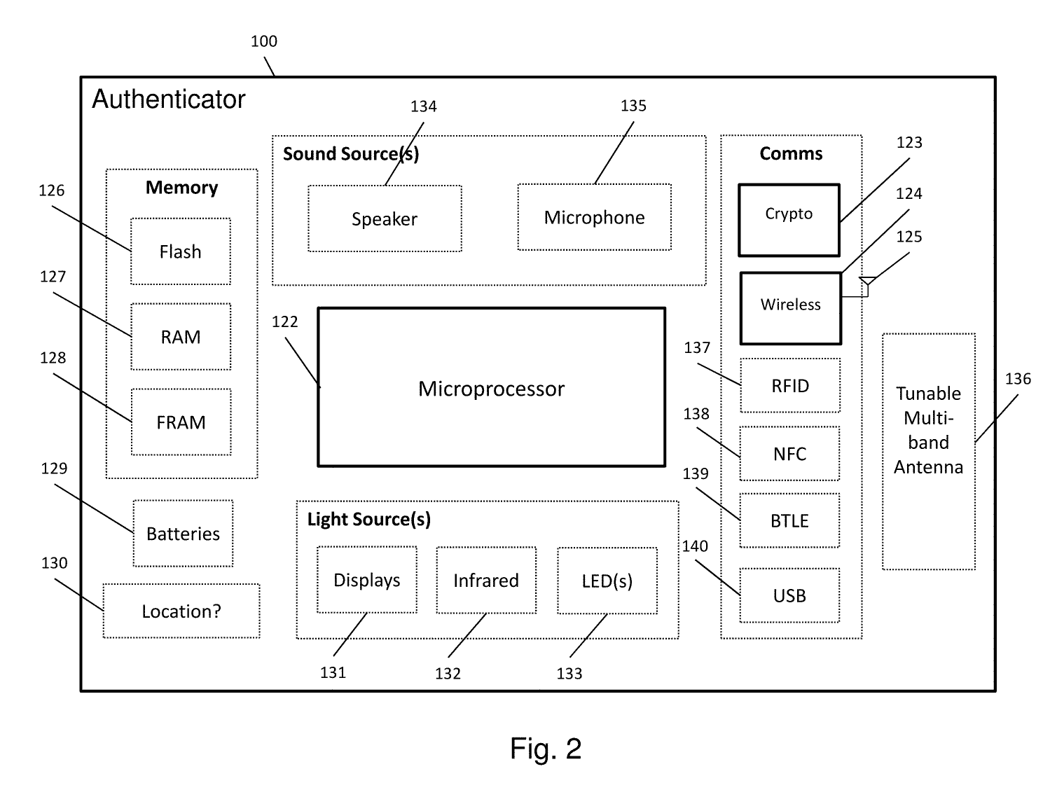

Hardware architecture: The hardware architecture of the authenticator 100 may vary, but generally comprises (see FIG. 2) a microprocessor 122, crypto device 123, a wireless communications device 124, and an antenna 125. Crypto device 123 in this sense is not simply a component that supports cryptographic encryption and/or decryption, it may also be, in some embodiments, an anti-tamper device with various features including but not limited to active shields, internal memory encryption, internal clock and voltage generation, glitch protection, voltage tamper detection, and/or secure test modes.

The authenticator 100 of FIG. 1 comprises software and/or hardware that may be packaged within any enclosure, including, without limitation, a wallet, ring, bracelet, necklace, watch, a wearable item, a phone, a mobile phone, a tablet, a FOB, a key ring, a key chain, a key chain accessory, a purse, a smart card, an identity card, a USB, a dongle or another mobile or static device, a computer, server, laptop, or another computing device, all collectively referred to as a package or enclosure. While components of the authenticator 100 are packaged within an enclosure, the functionality of the authenticator is likewise integrated into the functionality of the packaged device.

In addition, the authenticator may include, optionally in some embodiments, flash memory 126, RAM 127, FRAM 128 and/or other memory devices. Components such as batteries 129 and location/positioning devices 130 are also options. In some configurations, displays 131, infrared 132, LEDs 133 and/or other light sources may be installed on the authenticator 100 to support user interfaces, and light and imagery as a communication method. In other embodiments, a speaker 134 and/or microphone 135 are installed on the authenticator 100 to support voice as an interface and sound, music, tunes and the like as a communication method or as a user credential. In yet other embodiments, one or more variable multi-band and/or broadband or tunable antenna 136 may be installed to support various inductive data transfers and RF (radio frequency) communication techniques. In some configurations, the antenna 136, with associated circuitry, may also serve as a close proximity sensor, dynamic magnetic emulator and/or inductive charging device for use with peripheral devices, as well as a tunable wideband antenna that can be optimized at multiple frequencies.

The components associated with the following exemplary and non-limiting communications methods/protocols include: Wireless methods such as WiFi, RFID (Radio Frequency Identification) components 136, NFC (Near Field Communication) components 137, Bluetooth and BTLE (Bluetooth Low Energy) components 138. Serial methods such as RS-232 and USB (Universal Serial Bus) 140 can also optionally be supported. Other communication methods/protocols known to those skilled in the art can also be supported as desired.

In addition to the use of one or more communications methods (also referred to as communication protocols or techniques herein), including the examples set forth herein, the communications methods or protocols can be implemented over one or more frequencies. For example, after authentication has been successfully accomplished between two devices, a first segment of a data exchange between the devices is carried out on a first frequency, and a second segment is carried out on a second frequency. In another embodiment, the authentication process can be performed on a first frequency then the devices switch to a second frequency for exchanging data. For example, a first authentication credential is supplied over a first communication channel and a second authentication credential is supplied over a second communications, where both the first and second credentials are required for a successful authentication. Or a first authentication credential is supplied on a first frequency and a second authentication credential is supplied over a second frequency. Or in yet another example, a first segment of an authentication credential is supplied on a first frequency and a second segment is supplied on a second frequency. The authentication credential comprises, for example, a fingerprint digitized and segregated between the first and second segments, or a password that is similarly digitized and segregated between the first and second segments.

In one application the authentication credentials are embodied as tokens or cryptograms. For example, an authentication credential is embodied as two tokens. According to one embodiment of the present invention, the two tokens are sent separately, using different communication parameters, during the authentication process. This scheme makes it more difficult for a hacker to intervene in the communication session as the hacker must capture both tokens. Although a token is derived from one or more authentication credentials, the authentication credential is not determinable from the token.

In addition to switching frequencies, to thwart a would-be hacker, different segments of the data exchange or communication session can utilize different communication parameters or techniques, e.g., optical signals followed by RF signals, or a QPSK modulated signal followed by a DPSK modulated signal. A first segment of the communication session may be executed according to a near field communication scheme and a second segment of the session executed according to a far field communication scheme.

The first and second segments may be delineated by elapsed time or the number of data bytes, for example. Additionally, delineation of the segments may be dynamic as a function of time, e.g., during the first five minutes of the session 1000 bytes are considered the first segment and the remaining bytes are considered the second segment. But after five minutes the first segment comprises 10000 bytes and the second segment comprises all remaining bytes of the session. One or more of the communication parameters associated with the first segment are different from the communication parameters associated with the second segment.

Since no two entities or devices (e.g., midpoints and endpoints), applications and/or software necessarily support the same communications methods, communication frequencies, communications paths, and communication channels, and communications parameters, interfaces, encryption, compression and authentication techniques, etc. this invention is adaptable to support a variety of these communication parameters. This functionality is embodied in communicating devices, such as the midpoints 108 and the endpoints 110 of FIG. 1.

Any one or all components of the invention may comprise tamper-proof components that secure information using anti-tamper methods and devices to prevent intercept, hacking, interrogation or probing. System-on-chip combinations of any of these functions may also be included, as well as ASIC (application specific integrated circuit) implementations.

Choosing Authentication Credentials: According to one embodiment the authenticator 100 associated with a device, such as the wearable or mobile device 101, automatically detects the needed authentication credentials from applications, devices, webpages and/or services of other devices, such as the midpoint 108 or endpoint 110. As described elsewhere herein, the authenticator 100 may in fact represent a subsystem of the wearable or mobile device, or may comprise a separate device that operates in association with the wearable or mobile device 101.

Alternatively, authentication credentials may be requested of the authenticator 100 through a user interface on the authenticator and/or another device that communicates with the authenticator. Credentials may be sent to other devices without revealing the actual credentials to the user interface by using aliases (or tokens or cryptograms) for the credentials, so that the actual credentials always remain hidden. Furthermore, a user may select the appropriate credential via a user interface and manually enter that credential onto an active field of a display, for example.

In another alternative embodiment the authenticator 100 requests the necessary authentication credentials from other devices, such as the midpoint 108 or the endpoint 110.

In yet another embodiment, the user may choose from a list of login credentials, passwords, and/or aliases of login credentials. After successful authentication in which the user is authenticated to the device 101, the authenticator within the device 101 authenticates the user to another device with the other device, e.g., an endpoint 110 or a midpoint 108 by sending the authentication credentials to the other device. After all devices have been authenticated, a secure communication session can be conducted.

Furthermore, some embodiments include additional security features for bi-directional single and/or multi-factor authentication where a response to the authentication credentials is required from the other device, e.g., a midpoint 108 or an endpoint 110, (more specifically, their respective midpoint software 109 or endpoint software 111). This response may include PIN, pattern, gesture, password, passcode or passphrase, and/or other response as required to confirm identity, followed by new credentials sent according to an authentication method to the entities to complete the authentication process.

Authentication and Data Exchange Methods

As stated herein, the disclosed invention supports a number of approaches and methods (e.g., communication parameters) including but not limited to communications, authentication, modulation, baud rate, coding, encryption, compression, circles of access or circles of trust (i.e., trusted entities with whom a communicating entity has previously authenticated and communicated with, and therefore has established a history of secure communications), and other services that characterize how users and entities access endpoints, midpoints, and other entities. Since not every device supports the same communication methods/protocols/, a universal authentication service must support the same multiple communication, authentication, encryption and compression methods and communication frequencies that other entities support, or combinations of each in some embodiments. Those versed in the art recognize combinations of these and other methods may be supported within various hardware and/or software embodiments to achieve a flexible, universal authentication and data exchange service. The following list is not intended to be exhaustive, nor is it limited any specific embodiment.

Wake-up Method: An authenticator 100 may be configured to wake-up based upon a received “wake-up signal” 104 of FIG. 1. Some authenticators 100 may support awakening from a passive state and/or semi-passive state, in order to conserve power, while other authenticators 100 may support only wake-up signals from an active state, or combinations or all of three methods. Once a signal is detected, a resonant frequency awakens the microprocessor, which then determines the sensor characterization, authentication credentials, communication methods, protocols, channels, and frequencies, and authentication services. Once the communication method is determined, the corresponding communication subsection is then activated, and the authentication, encryption and compression methods of the entities are negotiated.

Passwords: As previously mentioned, multiple passwords may be stored within the authenticator, along with other information including but not limited to usernames, user IDs, URL, website, application name, application ID, encryption type, compression type, and encryption key. Passwords may be sent to entities over a variety of communication channels as disclosed.

Authenticators 100 may also generate unique passwords, and thus create strong, non-dictionary passwords and/or passphrases for secure authentication.

Authenticators 100 may also integrate with password “managers”, although many implementations of password managers are considered insecure.

Wireless Keyboard Implementation: One feature of this invention is that no integration is necessary for devices that support wireless keyboard protocols. In contrast to other password managers, this embodiment requires no integration to securely enter credentials. Instead, the authenticator 100 may connect to the host OS (operating system) as a keyboard using HID (Human Interface Device), SPP (Serial Port Profile) or other wireless protocol. Devices, websites, applications, services and virtually any entity that requires login credentials will automatically recognize the universal authentication device, and accept input via standard keyboard protocol. Thus, no custom integration is required since these entities recognize a keyboard as a standard device input.

Communication Method/Protocol/Channel/Frequency Selection: Alternatively, for entities that may not support keyboard protocols, the authenticator 100 supports various communication methods/protocols/channels/frequencies. Non-limiting examples include one or more audio channels, RF (radio frequencies), inductive, magnetic and/or light wavelengths, may be supported to maximize the number of entities that can interface with a universal authentication device. In some of these configurations, users and/or entities may choose which communication, authentication, compression, and/or encryption method to use with a specific entity. Since the methods used by a particular entity may not be known, some embodiments may also attempt to communicate with entities by automatically choosing their communication, authentication, compression, and/or encryption method. To determine which methods a particular entity might use, a number of approaches may be supported within various embodiments.

Multi-Factor Authentication (MFA): As described herein, one of the many purposes of this invention is to provide a bridge between older password-based methods of authentication and newer methods of authentication such as MFA.

However, the authentication sensors of this invention are not limited to the three customary “something you know, have and are” parameters. According to this invention, a number of factors or “identifiers” are supported, including but not limited to:
(A) user identifiers for identifying an individual, including but not limited to:
   (a) biometrics that may comprise, but not limited to, a voice, speaker, repeated word, face, 3D face, iris, finger, eye, eye vein, eye tracking, gesture(s), DNA, vein, palm, heartbeat, vibrometry, and/or scent;
   (b) secrets that may comprise, but not limited to, PINs, passwords, patterns, touch gestures, user defined actions and/or dynamic user sequences;
   (c) behaviors that may comprise, but not limited to, invalid attempts, input speed, input style, habits, sites visited, movements, gestures and/or interface actions such as canceling input or deleting characters;
(B) devices identifiers for identifying a device, including but not limited to:
   (a) unique internal serial numbers, MAC addresses and/or CRC;
   (b) device and/or wallet IDs;
   (c) unique device metrics such as vibrometry and/or electrical noise;
   (d) proximity sensor that may comprises two or more devices dynamically paired with one or more other specific entities that require authentication each other prior to enabling access to certain circles of access and/or other entities;
(C) groups identifier;
(D) locations identifiers for determining a location, including but not limited to a location, fence and/or proximity;
(E) one-time codes that comprise a random number;
(F) sessions and/or transactions or any transaction parameters permitted by a user to be performed with the account, such as single transaction limit, total limit, transaction type, and time of transaction;
(G) firmware and/or software and/or a signature that ensures firmware and software cannot be replaced; this method also may serve as a proximity sensor to guard against probing and interrogation;
(H) account identifiers such as alias, account numbers, wallet ID, user customizable card names, card type, CVV, charge limits and time duration
(I) credentials.

Each of these identifiers or factors possess something unique about an entity (a user, electronic device, location, an endpoint, etc.), that can be bound to an authenticator. These identifiers expand upon the “something you know, have and are” factors to include other factors not limited to “some serial number you have, group you belong to, your circles of access, your current location, firmware or software you have, proximity sensor you found, accounts you have, and/or how you behave, some of which are identified above.

These identifiers may be tested by the authenticator from inputs provided by authentication methods and/or sensors local to the authenticator or hosted on another device or entity. Binding identifiers to the authenticator enables the authenticator to then bind identifiers to other entities. A unique way to accomplish this without revealing the actual identifiers is via a new risk-aware method called dynamic pairing as described below and in co-pending application filed on Mar. 17, 2014 and entitled, The Un-Password™: Risk Aware End-to-End Multi-Factor Authentication via Dynamic Pairing, now U.S. Pat. No. 9,407,619 (Attorney docket 12188-010) the contents of which are incorporated herein.

Dynamic Pairing: The present invention supports an authentication technique referred to as dynamic pairing (as described and claimed in the application identified immediately above) that leverages these and any identifiers and/or “factors”. Dynamic pairing is a particularly attractive method of cryptographic authentication in that it provides authentication to endpoints via innovative pairing techniques that bind entities to identifiers without actually passing any information from which the identifiers could be derived. For each authentication attempt, this method masks an authentication score derived from various parameters collected from one or more authentication methods. Because of its innovative design, dynamic pairing is one way to add security to other existing authentication, encryption and compression methods.

Advantages of Dynamic Pairing: The advantage of dynamic pairing is that it also integrates well with other authentication methods such as SSL/SSL/TLS (secure socket layer/transport layer security), which is the “padlock” used by https (hyperText transfer protocol secure), and other methods that are becoming commonplace for “secure” data exchange over the internet and other communication channels. Dynamic methods are always better than static, given it is harder to derive a code from codes that are dynamically changing. Further, this method utilizes a priori information in the form of a history of authentications performed by a specific entity such that there is “inter-awareness” between endpoints, midpoints, users and other entities. This history is used to derive “how well” an entity is known by another entity, and thus, assess risk based on a current authentication attempt.

Other Advantages of Dynamic Pairing: With dynamic pairing, a new authentication score is masked within the combination of two or more authentication scores. It is a dynamic “shared secret” that is never revealed, hidden from any possible intercept. Common hacking methods such as a brute force attack would not impact this invention due to its inherent reliance upon risk analysis, which is dynamic per each session. As soon as any invalid attempts are made to decrypt the dynamic pairing code, the endpoint's cumulative risk score is increased and additional user identification information is requested per additional authentication methods. Other common spoofing techniques involving such methods as finding a common denominator among a group of similar keys would also not apply due to the dynamic nature of the keys (seeds) and lack of publically shared secrets (identifiers). Furthermore, “man-in-the-middle” attacks do not impact the integrity of the encrypted data due to the requirement for additional information to decrypt which only one side holds. With most dynamic pairing code embodiments, only one side of the communications link knows the new authentication score for the session. The other endpoint derives this value from the decrypted combined authentication score instead of it being sent in the clear and open. The dynamic pairing code, since it has risk information within its derivation, may communicate additional information, such as but not limited to credentials, access levels and/or circles of access.

In one embodiment, additional security may be provided by utilizing a midpoint device (such as the midpoint device 108 in FIG. 1), such as but not limited to a physical device such as a door knob, a virtual secure element, server or the like, that acts as a filter or firewall to thwart potential attacks by adding an authentication step in between the two endpoints using a variety of methods that validate each endpoint is real and authorized to act on behalf of a user or system identity. An endpoint may choose which circle of access to accept another endpoint or authenticator into, or make this automatic decision based upon the authentication score from another trusted endpoint, midpoint, or authentication service.

Rather than a “certificate” requiring some lengthy process with an unknown third party, a risk score may be integrated into the authentication process as a measure of an endpoint's probability of authenticity as derived from the history of successful and unsuccessful access attempts. In addition, an endpoint's circle of access is periodically revalidated as part of the dynamic pairing code update process to determine if the endpoint's authentication score has changed.

Hidden Private Information: A major advantage with dynamic pairing is that all identifiers and keys are managed by the user within his or her personal vault, not by some administrator unknown to the user, while still binding endpoints to identifiers through risk analysis to thereby achieve trust. In fact, no keys are even held, they are dynamically derived from dynamic pairing codes, which are in turn derived from authentications scores, which are derived from identifiers, some of which are likewise dynamic. No identifiers such as biometric keys, device identifiers and the like are ever revealed in the open, making interception pointless to an attacker. User secrets, such as biometric keys and templates, are always safe under this invention, with distribution of only derived codes under full control of the owner. Thus, under this embodiment using dynamic pairing, all private data is kept private, hidden from any exposure to attack.

Non-limiting Examples: Dynamic pairing is not limited to any specific software and/or hardware, and may utilize any authenticator that is used to authenticate “entities”, defined as users, devices, applications, services, servers, software and the like, to other entities. For a non-limiting example, a key used for standard door locks, which acts as an authenticator, may communicate to a keyhole, which acts as a midpoint, and a locking mechanism, which acts as an endpoint. The key is used to access the lock, but not without the midpoint recognizing first and the lock authenticating. If a new set of keys or a new method were introduced, both keys would have to be recognized as valid with the midpoint (key-hole). Once they both recognize they share that common peer, they can establish a peer-to-peer (P2P) connection between themselves to exchange identifiers. In the same way, a smart wallet, acting as an authenticator, may authenticate to an authentication server, acting as a midpoint, and also authenticate with a bank, acting as an endpoint, as another non-limiting example.

Dynamic Pairing using Symmetric Identifiers: Some applications may want, or already have, common identifiers on both sides of a communication link. Non-limiting examples of such applications include identification devices issued by banks, employers, governments, schools and the like. Under this embodiment, dynamic codes are generated from combinations of one or more unique identifiers and/or keys that are specific to factors including but not limited to users, devices, accounts, locations and/or sessions or transactions. Non-limiting examples of identifiers that may be used within this dynamic pairing method include biometrics, proximity sensors, user “secrets”, wallet ID, master encryption key, user customizable card names, card type, device serial number, vibrometry ID, electrical noise ID, CRC, MAC address, CVV, charge limits and time duration. In some embodiments, a high-quality random number generator, Identifiers, embedded key generator, and comparator are all safely hidden within the tamper-proof crypto chip at all times. Even the proprietary dynamic pairing code algorithm used to generate the dynamic pairing codes may be stored in a tamper-proof crypto chip as well, so that no information is ever available to be hacked.

The algorithm that generates the dynamic pairing code uses different combinations of these identifiers during different data sequences or at different time instances in combination with a high-quality random number generator local on the same protected crypto chip so that identifiers saved on the device are never externally accessible. The combination of which identifiers are used and when they are used is based upon a proprietary NXT-ID (assignee of the present invention) algorithm. Thus, only the generated random number and its response are ever shared between the first and second devices.

Challenge/response methods of authentication such as this method of dynamic pairing with symmetric identifiers have a distinct advantage by passing only pseudorandom numbers, without revealing any identifiers or keys. Furthermore, having the pseudorandom number generator, comparator and the key generator within the same tamperproof device that also holds the identifiers ensures all secrets are kept secure during authentication and encryption key generation.

Multi-planar, Multi-Purpose Tunable Antenna Method: Another embodiment supported within this invention is an innovative tunable antenna 136 that is described in a co-owned patents and applications, which are incorporated herein, Those patent documents include: U.S. Pat. No. 10,074,888 entitled Accordion Antenna Structure, issued on Sep. 11, 2018 (Attorney docket 12188-035); the application entitled Accordion Antenna Structure with Simplified Construction, filed on May 6, 2018, and assigned application Ser. No. 15/972,217 (Attorney docket 12188-035CIP); the application entitled Antenna with Microprocessor Control, filed on Sep. 10, 2018, and assigned application Ser. No. 16/127,125 (Attorney docket 12188-035CON).

The tunable multiband antenna 136 (see FIG. 1) transmits and receives signals over a wide band of frequencies. The tunable antenna also operates over magnetic and inductive links as well as RF (radio frequencies).

This antenna may also act as a dynamic magnetic stripe module such as described in co-owned and related patent application Ser. No. 14/049,175 filed on Oct. 8, 2013 and entitled Method for Replacing Traditional Payment and Identity Management Systems and Components to Provide Additional Security and a System Implementing Said Method. An antenna can be embedded within a smart or powered card and/or smart wallet that are dynamically paired to one another through the multi-planar, multi-purpose antenna to pass secure information, as a non-limiting example. Under this embodiment, these tunable antennas, along with associated circuitry, may serve multiple purposes including wake-up of a powered card, dynamic pairing authentication and/or data exchange between the smart wallet and card. On the card, the antenna may then be used to receive data from an authenticated smart wallet, detect a reader, exchange data between the card and reader, zeroize the card to make it “dumb” again, communicate other information such as but not limited to battery level and recharge its battery by receiving power from the smart wallet or other device via inductive charging.

Dynamic Pairing Use Within Payment Industry: In another embodiment, dynamic pairing may take place inside of a payment card, token, transaction, or other method. The present invention may be used to secure payment details as well as authorize a transaction using methods such as dynamic pairing. Furthermore, the present invention provides a method to hide the transaction details such as the card number or security code from the POS system to prevent private data from being stored or stolen. A tokenization method can be used within dynamic pairing such that the seed that encrypts the dynamic code also dynamically generates account details as well. Authentication Scores may also be used to determine risk for a current transaction. Endpoints may have dynamic risk score thresholds dependent upon various variables such as location, transaction amount, transaction type, and transaction frequencies. In this way, dynamic pairing provides a method by which certain transactions may be declined based upon the risk associated with that transaction as governed by the endpoint (e.g. the provider). Certain transactions may require higher authentication scores or specific authentication methods.

Wocket Number: In the above example, a private electronic vault, or smart wallet such as a wocket, may be may use a one-time “wocket number” dynamic pairing code generated by the smart wallet and/or the smart/powered card from authentication scores derived from identifiers on one or either devices. This code may include private information from the vault or the card, such as but not limited to aliases to accounts, locations, biometrics, credit card numbers, names, CVC, expiration date and the like. The location, biometric and other information may be used by the smart wallet and/or card in the account selection process. The vault may then send encrypted data to the second device via encrypted link, where the encrypted data is decrypted via its one-time-use encryption key and then sent by the second device via the appropriate transaction method of the point of sale (POS) system. If the transaction method is a common point of sale (POS) that utilizes magnetic stripe techniques, the second device may be a powered card with a dynamic multi-planar, multi-purpose tunable antenna. Thus, the second device could act as a conduit to support virtually any method of payment or communications.

User Configurable Method: In another embodiment, one method that may be utilized in negotiation of authentication and other parameters is for the user to configure one, combinations, or all frequently used methods and configure the authenticator to try each method in sequence to systematically determine the authentication method to be used for the entity. Under this embodiment, the authenticator knows the communication method once a response is detected from the entity in response to a request from the authenticator. Once the communication method is known, the authenticator negotiates the authentication method and subsequently the encryption and compression methods, etc. with the entity.

Trial-and-Error Method: In another embodiment, an approach to automate the detection of each of the methods may be utilized in which the authenticator simply attempts each communication method, then once it has received a response, attempts the authentication method, and so on. Variations of this “brute force, trial-and-error” approach may be implemented in some embodiments to support negotiation.

Cascading Authentication Method: When used in conjunction with multiple entities each wanting authentication, the authenticator can negotiate authentication with each entity in a cascading effect prior to authenticating with a final endpoint.

“Secure as you go” Unpasswords: Typing in a username and password, which is commonplace to access most computer systems, is now being replaced by newer methods of authentication that include biometrics and multi-factor authentication. Biometrics in particular are great additions to authentication, but market resistance has shown that users are not fond of sticking body parts into devices. Most users are accepting of new methods that are either fun to use, or that just authenticate automatically without knowledge of the user, referenced hereafter as “unpasswords.” “Secure as you go . . . ” unpassword technologies can authenticate a user passively, without requiring traditional “passwords” to access some device or account or length delays, body part, size, power and other aspects of authentication that is useless to the user experience.

In addition, the environment plays a factor in authentication. For example, voice recognition is impractical for noisy environments and finger is impractical where gloves are often worn. Thus, this invention will also sense the environment to determine the best authentication modality to use for a given authentication event.

Universal authenticators, and thus dynamic pairing, support various unpasswords authenticator methods including but not limited to sight word, sound word, passive voice, face password, blink recognition, user definable sequences such as most common buttons and/or applications initially used, approximation sequences such as images, doodle, gestures and typing patterns, soundpass, musicpass, tunepass, litepass, lightpass, dynamic user define sequences such as patterns that change moving images, game and sport ninja unpassword gestures, and the like.

Auto-Authentication Method: Under this embodiment, the authenticator may use some authentication method, such as a biometric, to automatically know who is accessing the authenticator. In this sense, the authenticator and user are “paired”, since the authenticator has verified the identity of the user using one or more authentication method whose result exceeded some predetermined threshold as it was compared to a corresponding identifier within the authenticator. Authentication methods can be local to the authenticator, or carried, worn, near or even far away, supported on some other device that is trusted by the authenticator using some method that establishes inter-awareness such as dynamic pairing.

Button Method: Under this embodiment, a button on the authenticator may be pressed by a user to turn the authenticator on or off. When on, the authenticator is ready to receive a request for authentication. When software on a requesting entity detects a device, webpage, browser, application and/or service that requires some authentication credentials, it sends a wake-up signal along with an authentication request to the authenticator, which then in turn receives the request and sends the authentication credentials to the requesting entity. In another embodiment that is a variation of this method, the button may be used to send the authentication credentials when it is pushed. The software on the entity communicates which credentials are to be used, but send's no wake-up signal under this embodiment.

Manual Selection Method: Under this embodiment, a user selects the credentials to send from a list. The list may be accessed locally, or on a peripheral or remote device.

Sensor Selection Method: Under this embodiment, entities and/or users may choose the authentication sensing method and number of sensors by which to authenticate. For instance, an entity requesting additional authentication might choose voice as a sensing method after verifying via a microphone on the authenticator that the environmental conditions to collect voice are good, as a non-limiting example.

Optional Companion Application: Although in some embodiments, entities such as endpoints 110, midpoints 108 and their associated software 109, 111 can communicate with authenticators without passing plain-text credentials via software intimate within the endpoints 110 and/or midpoints 108 themselves, in other embodiments authenticators may be recognized as keyboard devices by operating systems (OS) on the entities so that no integration is required. For yet other embodiments, a companion application 141 securely communicating with an authenticator via dynamic pairing may be deployed to entities to automatically detect a request for login credentials and/or serve as an interface with devices, applications, websites, services or other entities to negotiate wake-up, communication, authentication, encryption, compression and data exchange.

Detection of Authentication Credential Request: In some embodiments, the authenticator companion application 141 detects when authentication credentials are requested. Non-limiting examples include login and password fields on an active window, page or application that are detected by the companion application. Other non-limiting examples include messages from software, applications, services, browsers, web-pages, the operating system and/or other entities requesting authorization credentials that are intercepted by the companion application.

This companion application on the entity to be accessed detects the device, website, browser, application, service or other entity that requires some authentication credentials, and sends a wake-up signal along with an authentication request to the authenticator. The authenticator wakes up, receives the request, and sends the authentication credentials to the requesting entity.

Under this scenario, no user interaction is required. Those versed in the art will readily recognize that any or all steps in this authentication process could be manual, such as but not limited to the following methods.

In some embodiments, credentials sent from the authenticator to the companion application auto-fill the username, password, and other fields of the entity.

In other embodiments, the companion application 141 may support multi-factor authentication, auto-fill multi-pages of data, and/or handle complex passwords.

Authentication Service: In another embodiment, an authentication service may be used to provide additional security by interfacing with a server-side authenticator and phishing prevention system.

In another embodiment, the authenticator 100 may authenticate an entity with another authenticator, midpoint, authentication service and/or cloud to ensure the entity requesting authentication has not be compromised before releasing authentication credentials.

In yet another embodiment, the authentication service passes login credentials over a secure link to a local password manager and/or software application that then decrypts and communicates the login credentials to an application, device, webpage and/or service.

In an embodiment that directly connects one or more endpoints to the authenticator, the endpoint automatically wakes the authenticator by sending a wake-up signal 104 (see FIG. 1) along with a request and authentication method to the authenticator 100, which in turn responds with the correct authentication method 105 (see FIG. 1).

In other embodiments, a user interface, touch interface and/or button 150 (see FIG. 1) on the authenticator 100 may be used to activate and send the appropriate authentication signal 105 to an endpoint 111 or midpoint 108 as appropriate.

In another embodiment, authentication requests can be compared to identifiers associated with known entities not limited to URLs, IP addresses and/or other unique identifiers of an entity to validate midpoints or endpoints prior to releasing authentication credentials to prevent spoofing, phishing and pharming. In this embodiment, if the identifiers do not match, the credentials are not passed, reducing the possibility of a phishing attack by tracing the entity IP to a list of known valid endpoints.

Image-based communication method: Another communication method that can transfer pass codes includes image-based communications. In some embodiments of the invention, images such as but not limited to bar codes and QR codes may be generated and displayed on a universal multi-image and/or video.

Serial communication method: Traditional physical communication methods such as but not limited to serial communications can also negotiate authentication credentials. Serial methods such as but not limited to USB (all versions), RS-232 and other interfaces can be used in some embodiments to provide.

Embodiments are described with reference to the attached figures, wherein like reference numerals are used throughout the figures to designate similar or equivalent elements. The figures are not drawn to scale and they are provided merely to illustrate aspects disclosed herein. Several disclosed aspects are described herein with reference to example applications for illustration only. It should be understood that numerous specific details, relationships, and methods are set forth to provide a full understanding of the embodiments disclosed herein. One having ordinary skill in the relevant art will readily recognize that the disclosed embodiments can be practiced without one or more of the specific details or with other methods. In other instances, well-known structures or operations are not shown in detail to avoid obscuring aspects disclosed herein. Disclosed embodiments are not limited by the illustrated ordering of acts or events, as some acts may occur in different orders and/or concurrently with other acts or events. Furthermore, not all illustrated acts or events are required to implement a methodology in accordance with the embodiments. All examples and exemplary alternatives set forth in the application are merely for illustration and are intended as non-limiting examples and alternatives.

What is claimed is:

1. A first device for communicating with a second device, the first device comprising:
a communications component for sending and receiving information over a plurality of communication frequencies and according to a plurality of communication parameters;
an authenticating component for authenticating the second device according to an authentication credential received from the second device on a first selected communication frequency and according to first selected communication parameters that are supported by both the first and second devices; and
after authenticating the second device, the first and second devices for exchanging information according to a second selected communication frequency and second selected communication parameters that are supported by both the first and second devices.

2. The first device of claim 1 wherein one of the plurality of communication parameters comprises a wireless communication parameter operative over a wireless link at a frequency.

3. The first device of claim 1 the authenticating component operative to authenticate the first and second devices based on an authentication credential segregated into a first segment and a second segment, the authenticating component for receiving the first segment from the second entity over a first communication frequency and for receiving the second segment from the second entity over a second communication frequency different from the first communication frequency.

4. The first device of claim 1 the authenticating component operative to authenticate the first and second devices based on an authentication credential segregated into a first segment and a second segment, the authenticating component for receiving the first segment from the second device according to first communication parameters and for receiving the second segment from the second entity according to second communication parameters different from the first communication parameters.

5. The first device of claim 1 wherein the first and second devices exchange authentication information, including the authentication credentials, according to first communication parameters, and wherein thereafter the first and second devices exchange information according to second communication parameters, at least one of the second communication parameters different from the first communication parameters.

6. The first device of claim 1 disposed within one of a ring, a bracelet, a necklace, a wallet, a smart card, a watch, a wearable item, a key fob, a key ring attachment, a device receiving and sending information over a universal serial bus, a dongle, a mobile computing device, a static computing device, and a smart phone.

7. The first device of claim 1 wherein the plurality of communication parameters comprise one or more of a radio frequency parameter, a Bluetooth parameter, a Bluetooth low energy (BLE) parameter, a WiFi parameter, a radio frequency identification parameter, a near field communications parameter, an audio parameter, a wireless parameter, an image-based parameter, an optical parameter, and a quick response (QR) code-based parameter, a data compression parameter, a data encryption parameter, a data coding parameter, a data format, a data structure, a communications protocol, and a communication frequency.

8. The first device of claim 1 the authentication credential comprising a one-time-pass code authentication credential, a password, a challenge/response query, an authentication credential, a dynamic pairing authentication credential, a multi-factor authentication credential, or a biometrically-infused authentication credential.

9. The first device of claim 1 further comprising a sensing component for determining characteristics of an environment in which the first device is operating, and wherein the sensing component determines an authentication credential responsive to the characteristics.

10. The first device of claim 9 wherein a characteristic of the environment comprises a noisy environment.

11. The first device of claim 1 wherein a midpoint device is disposed in a communications path between the first and second devices, wherein first communication parameters govern communications between the first device and the midpoint device, and second communication parameters govern communications between the second device and the midpoint device.

12. The first device of claim 1 wherein an authentication scheme is selected responsive to prior authentication attempts and prior information exchanges between the first and second devices.

13. The first device of claim 1 wherein the second device is operated by a user, and the second device is authenticated to the first device responsive to the selected authentication credential supplied by the user to the second device and supplied by the second device to the first device, the second device comprising a plurality of input devices for receiving the authentication credential from the user.

14. A method for authenticating a first entity to a second entity, the method comprising:
the first entity supplying a first authentication credential to the second entity using a first communication scheme;
the first entity supplying a second authentication credential to the second entity using a second communication scheme, wherein the second authentication credential is different from the first authentication credential and wherein the second communication scheme is different from the first communication scheme; and
authenticating the first and second entities responsive to the first and second authentication credentials.

15. The method of claim 14 wherein the first and second communication schemes comprise different communication frequencies or different modulation types.

16. The method of claim 14 wherein the first authentication credential comprises a first token derived from the first authentication credential and the second authentication credential comprises a second token derived from the second authentication credential, the first and second authentication credentials not determinable from the respective first and second tokens.

17. A method for a first wireless communications device to authenticate and communicate with a second wireless communications device, the method comprising:
exchanging authentication information between the first and second wireless communications devices on a first communication frequency;
the first wireless communications device authenticating the second wireless communications device according to the authentication information; and
after the step of authenticating, the first and second wireless communications devices exchanging non-authentication information on a second communication frequency different from the first communication frequency.

18. A method for a first wireless communications device to authenticate and exchange information with a second wireless communications device, the method comprising:
exchanging authentication information between the first and second wireless communications devices according to first communication parameters that govern a communications link between the first and second communications devices;
the first wireless communications device authenticating the second wireless communications device according to the authentication information; and
after the step of authenticating, the first and second wireless communications devices exchanging information according to second communication parameters for the communications link.

19. The method of claim 18 wherein the communications parameters relate to one or more of a wireless frequency, a modulation scheme, a data coding scheme, a data encryption scheme, and a data compression scheme.

20. The method of claim 18 wherein a step of exchanging authentication information between the first and second wireless communications devices comprises the second wireless communications device providing an authentication credential to the first wireless communications device according to the first communication parameter, the first wireless communications device authenticating the second wireless communications device responsive to determining whether the authentication credential matches a stored authentication credential and determining whether the authentication credential has been provided according to the first communication parameters.

21. The method of claim 18 wherein the first communication parameters are predetermined or the method further comprising one of the first and second devices advising another of the first and second devices of the first communication parameters that are supported by the first and second devices.

22. The method of claim 18 the first wireless communications device authenticating the second wireless communications device according to the authentication information, and only when the first and second wireless communications devices are within a predetermined geographical range of each other.
